(19) United States
(12) Patent Application Publication
(10) Pub. No.: US 2015/0113079 A1
(43) Pub. Date: Apr. 23, 2015

(54) EMAIL ANALYSIS AND CONTROL

(71) Applicants: Ran Etgar, Modiin (IL); Dvir Zohar, Ramat Hasharon (IL)

(72) Inventors: Ran Etgar, Modiin (IL); Dvir Zohar, Ramat Hasharon (IL)

(21) Appl. No.: 14/396,405

(22) PCT Filed: May 20, 2013
(86) PCT No.: PCT/IB2013/054120

§ 371 Date: Oct. 23, 2014

Related U.S. Application Data
(60) Provisional application No. 61/694,784, filed on Aug. 30, 2012.

(51) Int. Cl. H04L 12/58

(52) U.S. Cl. CPC H04L 51/22
USPC 709/206

(57) ABSTRACT

Email analysis and control system comprising: at least one server comprising an email exchange module and an email control module; and a plurality of users' computers running an email application and a client application communicating with the email application, the email control module comprising a rules database and a server program communicating with the client application, the client application configured to analyze each email sent by the user's email application, determine its importance or relevancy to each addressee according to the rules and act accordingly, the client application further configured to analyze each email received by the user's email application, determine its importance or relevancy to the user according to said rules and act accordingly.

### CROSS-REFERENCE TO RELATED PATENT APPLICATIONS

This patent application claims priority from and is related to U.S. Provisional Patent Application Ser. No. 61/694,784, filed Aug. 30, 2012, this U.S. Provisional Patent Application incorporated by reference in its entirety herein.

### FIELD OF THE INVENTION

The invention is generally in the field of email delivery control and more specifically optimizing organizational email systems with respect to number and quality of addressees.

### BACKGROUND

Email is one of the predominant communications means these days, in general and specifically inside organizations. However, the ease of sending an email and particularly the ease of addressing the email to a plurality of addressees (e.g. predefined groups and options such as ‘reply all’) has turned the email tool into a burden. Employees of all ranks, especially in information-abundant organizations, find themselves unable to cope with the quantities of email messages they receive, a majority of which is irrelevant to them.

Email senders often do not consider the relevancy of the specific email message to the specific addressees and the resultant time wasted on the addressees' side.

There is need for a method that will perform real-time analysis of sent email messages, determine their importance or relevancy to each addressee and act accordingly.

### SUMMARY

According to a first aspect of the present invention there is provided an email analysis and control system comprising: at least one server comprising an email exchange module and an email control module; and a plurality of users' computers running an email application and a client application communicating with said email application, said email control module comprising a rules database and a server program communicating with said client applications, said client application configured to analyze each email sent by said user's email application, determine its importance or relevancy to each addressee according to said rules and act accordingly, said client application further configured to analyze each email received by said user's email application, determine its importance or relevancy to said user according to said rules and act accordingly.

Acting accordingly by the client application may comprise not sending an email message to an addressee.

Acting accordingly by the client application may comprise\ not storing a received email in the recipient's inbox.

The rules may comprise organizational rules and individual user rules.

The individual user rules may be updated based on said user's behavior.

Each one of said rules may be defined as one of absolute and relative.

Each one of said rules may be defined as one of positive and negative.

Each one of said rules may be assigned an importance level.

The user application may be further configured to analyzed an opening delay of each received email message.

According to a second aspect of the present invention there is provided a method of analyzing and controlling sent email messages comprising: providing at least one server comprising an email exchange module and an email control module; providing a plurality of users' computers running an email application and a client application communicating with said email application, said email control module comprising a rules database and a server program communicating with said client applications; analyzing by said client application each email sent by said user's email application, determining its importance or relevancy to each addressee according to said rules and acting accordingly; and analyzing by said client application each email received by said user's email application, determining its importance or relevancy to said user according to said rules and acting accordingly.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic block diagram showing the components of the system for carrying out the method of the present invention;

FIG. 2 is a general flowchart of the email process according to the present invention; and

FIG. 3 is a flowchart showing the various steps taken by the method of the present invention, using the rules, to determine whether an email message should be sent to a specific addressee or received by a certain recipient.

### DETAILED DESCRIPTION OF PREFERRED EMBODIMENTS

The present invention provides a system and method for overcoming the shortcomings of existing organizational email systems by performing real-time analysis of sent email messages, determining their importance or relevancy to each addressee and acting accordingly.

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a social parking platform.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In general, embodiments of the invention can be implemented in any of a variety of hardware/software configurations. A particular embodiment includes at least one client computer and at least one server computer. The client(s) and server(s) may be executing on a common machine or may be deployed in distributed environment in which the client(s) and server(s) communicate via a network. However, the client-server model is merely one model in which the present invention may be implemented, and persons skilled in the art will recognize other possibilities. Furthermore, embodiments of the present invention can apply to any appropriate hardware configuration, regardless of whether the computer systems are complicated, multi-user computing apparatus, single-user workstations, network appliances that do not have non-volatile storage of their own or handheld devices such as personal digital assistants (PDAs), laptops, tablet computers and mobile telephones. Further, it is understood that while reference may be made to particular software products, the invention is not limited to a particular software product, standard or version nor to any particular programming language. Accordingly, persons skilled in the art will recognize that the invention is adaptable to other software products and that the invention is also adaptable to future versions of a particular software product as well as to other suitable software products presently unknown.

The method of the present invention, as incorporated in a computer program, may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

According to the present invention, whenever an email is sent inside the organization, the addressee list is analyzed for importance and relevancy and if a determination is made that at least one of the addressees should not receive this email message, a notification to that effect is sent to the email sender. The sender may act accordingly, i.e. delete the addressee from the addressee list or override the system notification and proceed with sending the email to the original addressee list.

According to the present invention, whenever an email is received inside the organization a similar relevancy and importance analysis is done for each recipient. Email messages determined to be irrelevant or unimportant for the recipient are routed to a separate email folder of the recipient.

According to embodiments of the invention, the method of analyzing email messages comprises a learning algorithm, as will be explained in detail below.

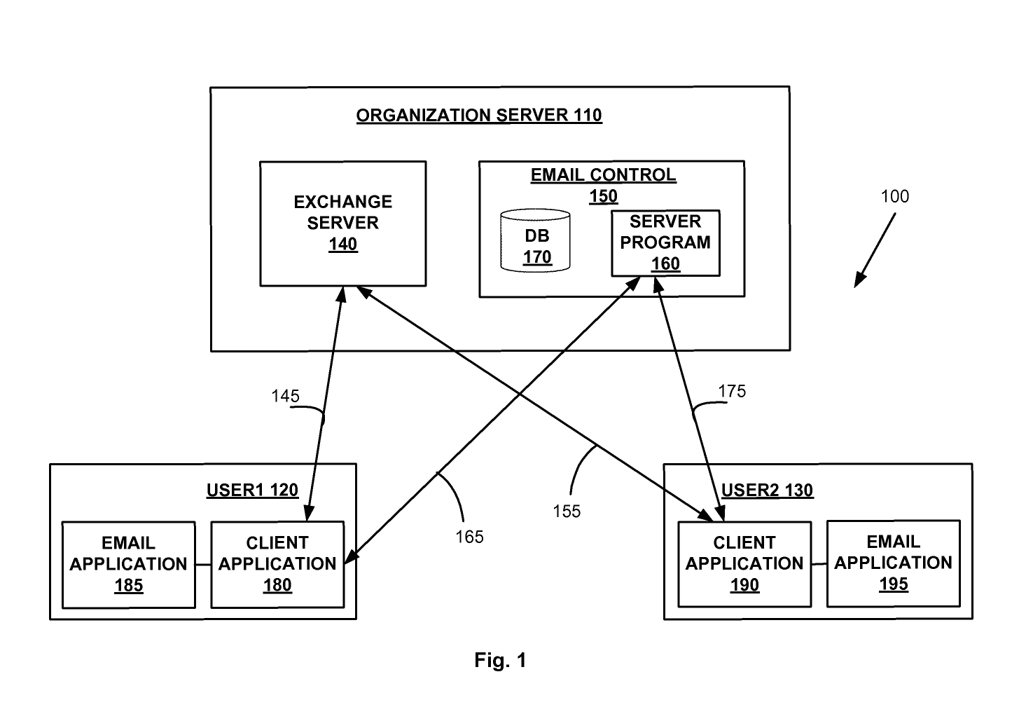

FIG. 1 is a schematic block diagram showing the components of the system for carrying out the method of the present invention.

The system 100 comprises:
An organization server 110, which may be one of a plurality of servers used by the organization; and
A plurality of user computers/terminals (only two shown, 120, 130) within the organization.

The organization server 110 comprises an exchange server 140, such as Microsoft Exchange Server 2010 and an email control module 150 comprising a server side program 160 for carrying out the server side according to the present invention and at least one database 170.

It is within the scope of the invention that the exchange server 140 and the email control module 150 reside on two separate organizational servers (or even on outsourced server).

Each user computer/terminal (120, 130) comprises an email application (185, 195), such as Microsoft Outlook 2010 and a client application (180, 190) for carrying out the client side according to the present invention.

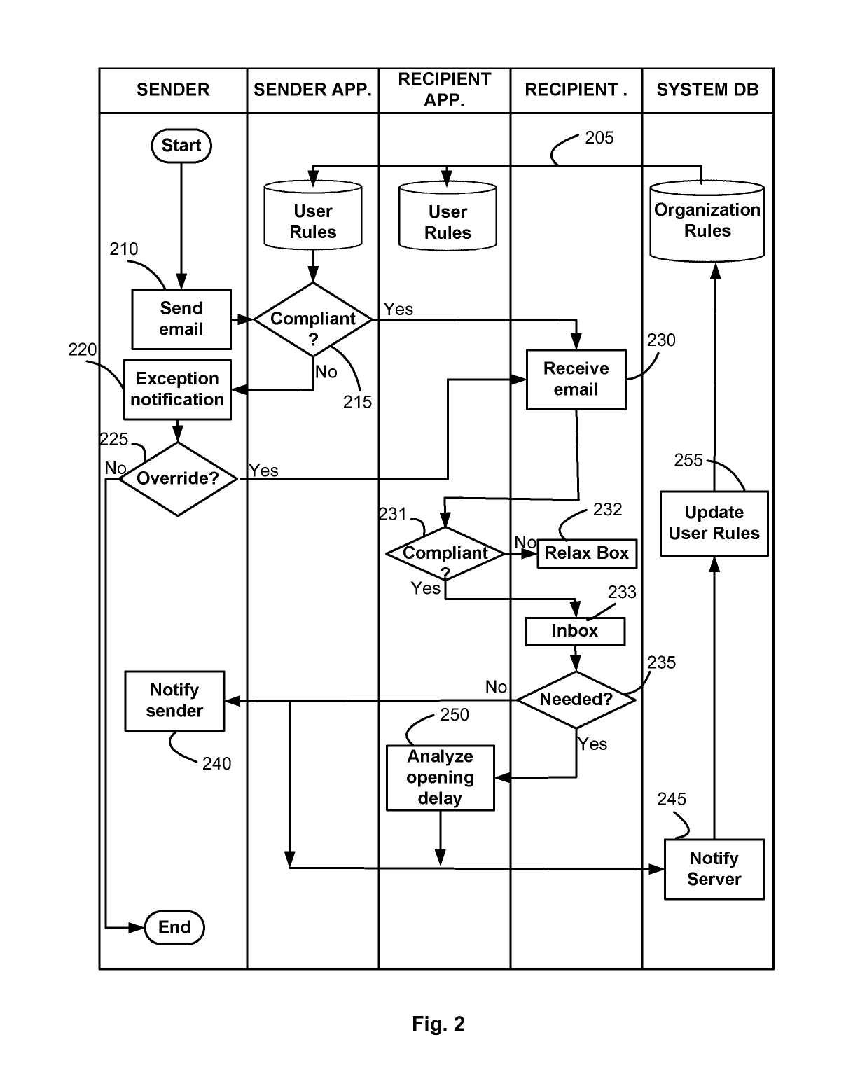

Database 170 stores organizational rules pertaining to email policy and personal user rules adapted from the organizational rules by the learning capabilities of the system. Selective adaptation of user rules is performed by the server program analyzing user behavior data provided by the user application, as will be explained in detail with reference to FIG. 2. Adapted user rules are downloaded by the server application to the relevant user application.

FIG. 2 is a general flowchart of the email process according to the present invention.

In an initial step, e.g. after system installation, the server program downloads 205 the organization rules from the central database 170 onto the various user applications, to be stored therein as initial user rules.

In step 210 the sender (i.e. one of the users) composes an email message and addresses the email to at least one other user, i.e. the recipient.

In step 215 the sender's user application checks each one of the new mail message's addressees against the user rules stored therein for the sender.

For each non-compliant addressee, the sender is noted of the exception (step 220) and is provided with the opportunity to override the exception condition, i.e. choose to send the email to the addressee despite the exception notification (step 225). If the sender chooses to override the exception, or if the addressee was found to be in compliance with the user rules of the sender, the email message is sent to the recipient.

In step 230 the recipient receives the email message.

In step 231 the recipient's user application checks whether the received email message complies with the user rules stored therein for the recipient. Non-compliant email messages may be stored in a dedicated mailbox 232 in the recipient's email application (e.g. Relax Box), other than the user's regular Inbox, so ad not divert the user from his current occupation but still enable him to view the non-compliant email messages at a later time.

Email messages determined by the recipient's user application to be compliant with his user rules are stored in the user's Inbox (233).

It is within the provision of the invention that the user may move email messages from his Relax Box to his Inbox, thereby overriding the rule that caused the message to be stored in the Relax Box in the first place. Such overriding may cause the recipient's user application to update the user rules stored therein and further to upload the updated user rules to the system database.

In step 235, when the recipient opens the new email message, he is prompted to let the application know whether he thinks he should have received this new email message, which was deemed compliant according to his current user rules. If the answer is negative, the sender is notified (240) and the sender's user application notifies the server application of the event (245). Otherwise, if the answer is positive, i.e. the recipient thinks he should have received the email message, the system proceeds to analyze the opening delay for this email message, namely the time lapse between receiving the email message and opening it. In step 245 the recipient's user application decides whether to notify the system server, in view of the analyzed opening delay. Updated user rules and/or rules' parameters are determined by the server (255) and downloaded to the appropriate users (205), thus creating a learning system.

The method of the present invention is based on an algorithm that attempts to evaluate the extent to which receiving a specific email message is required by a recipient and the extent to which a sender will decide to send a specific email message to one or more addressees, by trying to emulate the human decision making process. Since human decision making often does not rely on absolute rules, but rather on relative rules, some of which even contradict each other, so does the algorithm of the present invention.

The algorithm is based on a set of elementary rules having the following characteristics:

1. The rules relate to the content of the email message, its distribution list, its attachments and the history of the email thread;

2. A small number of rules are absolute, i.e. structured as “if X then definitely Y”;

3. Most of the rules are fuzzy', i.e. structured as “if X then probably Y”, thus the rules must be weighed by using fuzzy logic;

4. Some of the rules (both fuzzy and absolute) may contradict each other;

5. Each rule may be regarded as a function, i.e. each rule analyzes a characteristic of the email message and returns a numerical value, e.g. between 0 and 1, which is the equivalent of a reply to the human question “is this characteristic strengthening or weakening the claim that sending this email message to addressee A is worthy and will not waste his time?” For example, a rule that looks at whether the sender has indicated the email message as ‘important’ or not will be implemented as a simple function that returns ‘0’ if the sender has not indicated the email message as ‘important’ and a positive value otherwise.

6. Each rule is defined by:
a. Absolute or fuzzy—despite the fuzzy nature of human decision making, it is possible to determine absolute rules in some cases. For example, a rule stating that an email message sent by the CEO is always sent, independent of its other characteristics.
b. Positive or negative (polarity)—since the method deals with various characteristics, some of the rules, when complied with, strengthen the assumption that the email message is needed by the recipient and some weaken this assumption. For example, a rule stating that it is preferable not to send email messages to the highest ranks in the organization is a negative rule, since most organization are averse to ‘flooding’ higher management with mail from low rank employees. In contrast, the opposite rule of sending email messages from higher management to employees is a positive rule.
c. Importance—each rule is allocated an importance level, i.e. the extent to which it impacts the decision process. Some rules originate from organizational decisions (e.g. “you may not address an email message to a person ranked 3 levels above you”) and are therefore important, while other rules are less important. The relative importance of a rule is expressed as a number (weight) between 0 and 1. Absolute rules are not assigned an importance value. It is important to note that the importance value of a rule is not necessarily the same for different users; specifically, the same rule may have different levels of importance for a sender and a recipient of an email message.

7. The rules database is updated periodically, due to changes in organizational decisions and/or to knowledge gained by experience via the learning mechanism of the system. However, the basic algorithm for weighing the rules does not change.

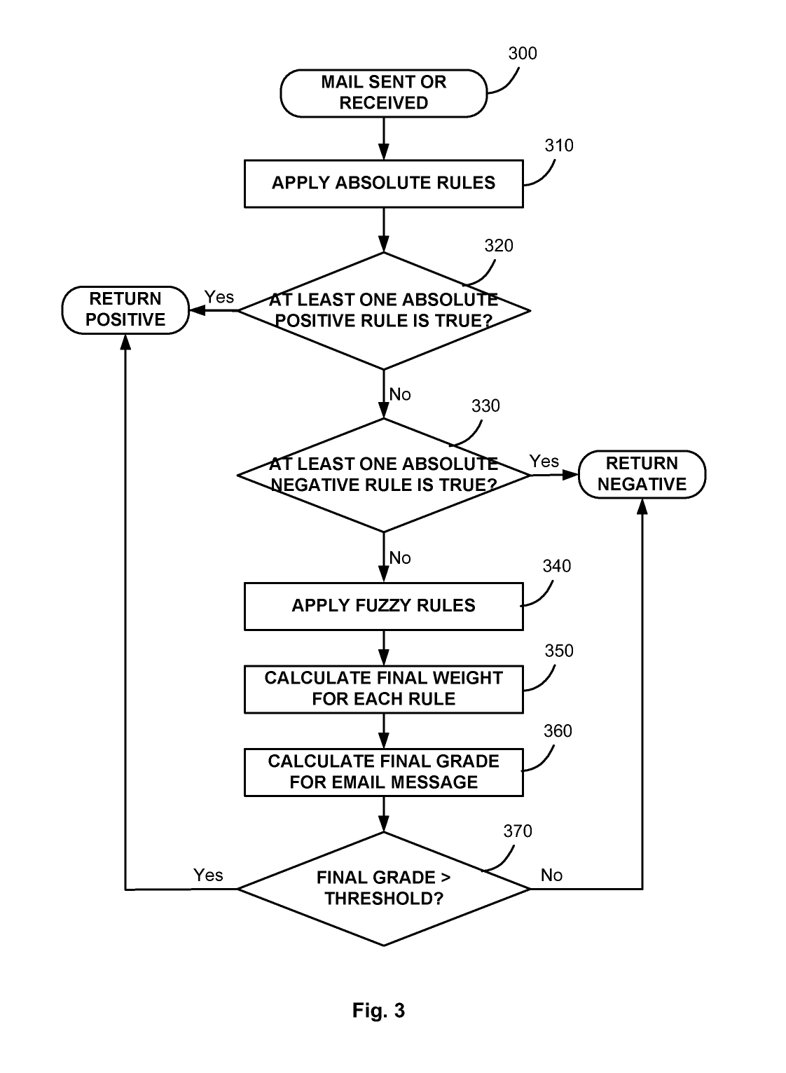

FIG. 3 is a flowchart showing the various steps taken by the method of the present invention, using the rules, to determine whether an email message should be sent to a specific addressee or received by a certain recipient.

In step 300 an email is sent by a sender or received by a recipient. In step 310 the absolute rules are applied to the email message. If at least one positive absolute rule returns TRUE (320), the algorithm returns “Positive”, i.e. the email should be sent (or received). Otherwise, if no positive absolute rule is true but at least one negative absolute rule returns TRUE (330), the algorithm returns “Negative”, i.e. the email should not be sent (or received).

When there are no absolutes rules to make the determination, the fuzzy rules are applied (340) to the various characteristics of the email message, resulting in a series of values, one per fuzzy rule, calculated by the respective functions, as will be explained in detail below.

In step 350 the final weight is calculated for each rule, using the value returned by the function (aᵢ), the importance (weight) assigned to the rule (wᵢ) and the polarity of the rule (sᵢ), where sᵢ=1 if the rule is positive and sᵢ=0 if the rule is negative. The final weight of a rule is calculated as pᵢ=aᵢ×wᵢ. As can be seen, the extent to which the rule is true is weighted by its importance.

In step 360 a final grade P is calculated for the email message, where

$$P = [ 1 - {\prod }_{∀ {s}_{i} = 1} ( 1 - {p}_{i} ) ] {\prod }_{∀ {s}_{i} = - 1} ( 1 - {p}_{i} )$$

Unlike the cases where absolute rules were used to reach an absolute final decision, when fuzzy rules are applied the final grade of the email is compared to a predetermined threshold (e.g. 0.5) and the determination is made accordingly (370). The threshold level (as other parameters) changes over time according to the learning mechanism.

### EXAMPLE 1

Assume our database comprises three rules, all positive, i.e. support a decision to send/receive the email message. Following are the values received in step 350 above:

| | | Calculated | |
|---|---|---|---|
| Rule | Importance wᵢ | value aᵢ | Polarity sᵢ |
| 1 | 0.3 | 0.75 | + |
| 2 | 0.5 | 0.85 | + |
| 3 | 0.4 | 0.60 | + |

First the final weight is calculated for each rule, resulting in:

| Rule | Final weight pᵢ |
|---|---|
| 1 | 0.225 |
| 2 | 0.425 |
| 3 | 0.240 |

It can be seen that none of the rules has a high final weight, or put in human language “none of the rules is decisive”.

Now the final grade of the email message may be calculated:

$$P = [ 1 - {\prod }_{∀ {s}_{i} = 1} ( 1 - {p}_{i} ) ] = 0.661325$$

It can be seen that the aggregation of rules has yielded a relatively high number.

### EXAMPLE 2

Assume our database comprises three positive rules and three negative rules. Following are the values received in step 350 above:

| | | Calculated | |
|---|---|---|---|
| Rule | Importance wᵢ | value aᵢ | Polarity sᵢ |
| 1 | 0.3 | 0.75 | + |
| 2 | 0.5 | 0.85 | + |
| 3 | 0.4 | 0.60 | + |
| 4 | 0.1 | 1.00 | − |
| 5 | 0.2 | 0.80 | − |
| 6 | 0.5 | 0.30 | − |

First the final weight is calculated for each rule, resulting in:

| Rule | Final weight pᵢ |
|---|---|
| 1 | 0.225 |
| 2 | 0.425 |
| 3 | 0.240 |
| 4 | 0.100 |
| 5 | 0.160 |
| 6 | 0.150 |

Now the final grade of the email message may be calculated:

$$\begin{matrix}P = [ 1 - {\prod }_{∀ {s}_{i} = 1} ( 1 - {p}_{i} ) ] {\prod }_{∀ {s}_{i} = - 1} ( 1 - {p}_{i} ) \\ = 0.661325 \times 0.6426 \\ = 0.424967\end{matrix}$$

It can be seen that the negative rules have reduced the final grade from 0.66 to 0.42.

The various rules' parameters (e.g. importance) and various constants defined in the functions provide means for continuously adapting the system to the organization's needs. The initial (default) setting of these parameters may be done based on historical databases of the organization, which provide data regarding past email-related behavior. In the course of time, the parameters will be updated according to user feedback, explicit and implicit, so as to achieve a more accurate emulation of the human decision making process.

The method described above has many advantages including:
A self learning method that adapts itself to the organizational needs;
A good starting point (accumulated knowledge reflected in default values)
The more rules in the system—the better the decision process (a rule cannot have an adverse impact; in the worse case it will receive the value 0).

### EXEMPLARY RULES (FUNCTIONS)

Following are non-limiting examples of rules defined in the system of the present invention and the functions used to calculate grades for the rules. As explained above, each function returns a value between 0 and 1.

a. Organizational Level of Receiver (Negative, Relative)

The function returns a value proportional to the receiver's organizational level: G=(1+(1−L)/(D−1))*(B−A), where L=the receiver's organizational level, D=number of levels in the organization and A, B are transformation parameters.

b. Organizational Level of Sender (Positive, Relative)

The function returns a value proportional to the sender's organizational level: G=(1+(1−L)/(D−1))*(B−A), where L=the sender organizational level, D=number of levels in the organization and A, B are transformation parameters.

c. Mail Indicated ‘Important’ (Positive, Relative)

The function has two parameters A and B. If mail is indicated ‘important’ G=A, otherwise G=B.

d. Sender is ‘Distinguished’ (Positive, Absolute)

The function has two parameters A and B. If sender is in list of distinguished people G=A, otherwise G=B.

e. Sensitive Words (Negative, Relative)

The function has one parameter A. There exists a list of words predefined as sensitive. Each of these words has a “sensitivity-level” (a number between 0 and 1—the higher the number the more sensitive the word). G=MAX(1, ΣL/A), where ΣL is the sum of all sensitive words' levels.

f. Number of Addressees—N (Negative, Relative)

The function has one parameter A. G=MIN(1, (N−1)/(A−1))

g. Recipient in CC—Relevant Only When Received (Negative, Relative)

If recipient is in CC then G=1, otherwise G=0.

h. Mail to Manager or Subordinate—Relevant Only When Sent—(Negative, Relative)

The function counts then number of “connections” in the addressee list. Two addressees are considered to be connected if there is a direct set of subordination relations between them (i.e. addressee X is the manager of the manager of . . . of addressee Y). The number of connections is N.

The function has 1 parameter A.

G=MIN(1, N/A)

i. Mail from Superior—Relevant Only When Received (Positive, Absolute)

If sender is recipient's superior G=1, otherwise G=0.

j. Number of Addressees N—Relevant Only When Sent (Negative, Relative)

The function has one parameter A. G=MIN(1, (N−1)/(A−1))

k. Amount of Information Sent—Relevant Only When Sent (Negative, Relative)

The function has one parameter A. N=info size×number of addressees in organization. G=G=Min(N/A, 1)

l. Sender's Grade—Relevant Only When Received (Negative, Relative)

The function returns the sender's grade as stored in the system.

1. Email analysis and control system comprising:
at least one server comprising an email exchange module and an email control module; and
a plurality of users' computers running an email application and a client application communicating with said email application,
said email control module comprising a rules database and a server program communicating with said client applications,
said client application configured to analyze each email sent by said user's email application, determine its importance or relevancy to each addressee according to said rules and act accordingly,
said client application further configured to analyze each email received by said user's email application, determine its importance or relevancy to said user according to said rules and act accordingly.

2. The system of claim 1, wherein said acting accordingly by the client application comprises not sending an email message to an addressee.

3. The system of claim 1, wherein said acting accordingly by the client application comprises not storing a received email in the recipient's inbox.

4. The system of claim 1, wherein said rules comprise organizational rules and individual user rules.

5. The system of claim 4, wherein said individual user rules are updated based on said user's behavior.

6. The system of claim 1, wherein each one of said rules is defined as one of absolute and relative.

7. The system of claim 1, wherein each one of said rules is defined as one of positive and negative.

8. The system of claim 1, wherein each one of said rules is assigned an importance level.

9. The system of claim 1, wherein said user application is further configured to analyzed an opening delay of each received email message.

10. A method of analyzing and controlling sent email messages comprising:
providing at least one server comprising an email exchange module and an email control module;
providing a plurality of users' computers running an email application and a client application communicating with said email application,
said email control module comprising a rules database and a server program communicating with said client applications;
analyzing by said client application each email sent by said user's email application, determining its importance or relevancy to each addressee according to said rules and acting accordingly; and
analyzing by said client application each email received by said user's email application, determining its importance or relevancy to said user according to said rules and acting accordingly.

11. The method of claim 10, wherein said acting accordingly by the client application comprises not sending an email message to an addressee.

12. The method of claim 10, wherein said acting accordingly by the client application comprises not storing a received email in the recipient's inbox.

13. The method of claim 10, wherein said rules comprise organizational rules and individual user rules.

14. The method of claim 13, further comprising updating said individual user rules based on said user's behavior.

15. The method of claim 10, wherein each one of said rules is defined as one of absolute and relative.

16. The method of claim 10, wherein each one of said rules is defined as one of positive and negative.

17. The method of claim 10, wherein each one of said rules is assigned an importance level.

18. The method of claim 10, wherein said user application is further configured to analyzed an opening delay of each received email message.

19. A computer storage medium tangibly embodying a program of machine-readable instructions executable by a digital processing apparatus to perform the method of claim 10.
